(19) United States
(12) Patent Application Publication
(10) Pub. No.: US 2025/0236327 A1
(43) Pub. Date: Jul. 24, 2025

(54) CART PROVIDED WITH PEDAL CAPABLE OF SYNCHRONOUSLY BRAKING TWO CASTERS

(71) Applicant: Zhejiang Pride Leisure Products Co,. Ltd., Jinhua (CN)

(72) Inventor: Benlong SUN, Jinhua (CN)

(21) Appl. No.: 19/023,323

(22) Filed: Jan. 16, 2025

(30) Foreign Application Priority Data
Jan. 19, 2024 (CN) 202420139910.7

(51) Int. Cl. B62B 5/04; B62B 3/02

(52) U.S. Cl. CPC B62B 5/0433; B62B 3/025; B62B 5/0457

(57) ABSTRACT

A cart provided with a brake assembly capable of synchronously braking two casters having a cart frame. Two front casters and two rear casters are symmetrically arranged at the bottom of the cart frame. A brake mechanism is arranged on the two rear casters and having a connecting tube, a pedal mounted on the connecting tube and two brake assemblies mounted at ends of the connecting tube respectively. Two ends of the connecting tube are connected to the two brake assemblies respectively. The pedal drives the connecting tube to rotate, and limit portions of the brake assemblies abut against limit pieces on the rear casters to bake the rear casters. The two rear casters can be braked synchronously, thus improving the braking efficiency of the cart in the moving process.

### BACKGROUND OF THE INVENTION

### 1. Technical Field

The invention belongs to the technical field of carts, and particularly relates to a cart provided with a pedal capable of synchronously braking two casters.

### 2. Description of Related Art

Most carts on the present market, especially carts used outdoors, are not provided with brakes. For example, Chinese Patent Publication No. CN219904428U discloses a folding cart, which is manually pushed to move forwards and is stopped directly by a manual pull in most cases; when the cart is loaded with goods, it will take a long time and a great manual pull to stop the cart without brakes. Some carts adopt casters with brakes as two front casters to ensure that the carts can be stopped in the moving process. When such carts need to be stopped, users step on a brake pedal on any one of the two front casters with one foot. However, because the two front casters are braked separately, when users step on one brake pedal with one foot, only one caster will be stopped, the other caster will not be stopped, and the cart will continue to move a certain distance.

### BRIEF SUMMARY OF THE INVENTION

In view of the defects in the prior art, the objective of the invention is to provide a cart provided with a pedal capable of synchronously braking two casters. Two rear casters of the cart can be braked synchronously, thus improving the braking efficiency of the cart in the moving process.

To fulfill the above objective, the invention adopts the following technical solution: a cart provided with a pedal capable of synchronously braking two casters comprises a cart frame, wherein two front casters and two rear casters are symmetrically arranged at a bottom of the cart frame; a brake mechanism is arranged on the two rear casters and comprises a connecting tube, a pedal mounted on the connecting tube and two brake assemblies mounted at ends of the connecting tube respectively; and two ends of the connecting tube are connected to the two brake assemblies respectively, the pedal drives the connecting tube to rotate, and limit portions of the brake assemblies abut against limit pieces on the rear casters to bake the rear casters.

Further, the cart frame is connected to the rear casters by means of a hub connecting piece, each brake assembly comprises a tube sleeve and a tube plug, the tube sleeves, the ends of the connecting tube and the tube plugs are sequentially arranged from outside to inside and fixedly connected, the limit pieces on the rear casters are located in limit grooves in ends of the tube plugs, and the ends of the tube plugs are rotatably connected to hubs of the rear casters.

Furthermore, flanges are arranged at the ends of the tube plugs, a limit groove is formed in a side of each flange, each limit piece comprises a protrusion arranged on the hub of the corresponding rear caster and a stop piece located on a side face of the protrusion, and the stop pieces are located in the limit grooves

Furthermore, each brake assembly further comprises a positioning piece mounted in the tube plug and penetrating through the corresponding end of the connecting tube.

Further, a handle tube is arranged on a back side of the cart frame, two ends of the handle tube are rotatably connected to two sides of the back side of the cart frame, and positioning and locking mechanisms are arranged at the ends of the handle tube; and each positioning and locking mechanism comprises a right shell mounted on the cart frame, a gear fixed in the right shell, a left shell fixed to the handle tube and a locking piece in clearance fit with the left shell.

Furthermore, the left shell is provided with a hinge pin penetrating through the locking piece and the gear, a limit pillar and a wedge block are arranged on portions, located on a side face of the hinge pin and outside the hinge pin, of an inner surface of the left shell respectively, a groove allowing the limit pillar to move therein is formed in an inner wall of a center hole of the locking piece, and a wedge groove matched with the wedge block is formed in a surface of the locking piece.

Further, a canopy is mounted at a top of the cart frame and comprises a cloth cover and a canopy frame, the canopy frame comprises four support rods, four top rods and a center seat, the four top rods are symmetrically and rotatably connected to four corners of the center seat, each top rod is rotatably connected to a top of one support rod, and a bottom of each support frame is detachably connected to the top of the cart frame.

Further, the cart frame comprises a front frame, a rear frame, a chassis and two side frames, the front frame and the rear frame are identical in structure, the front casters are arranged at a bottom of the front frame, and the rear casters are arranged at a bottom of the rear frame; the front frame comprises a frame body formed by two vertical tubes, an upper horizontal tube and a lower horizontal tube, fixing seats are arranged at tops of the vertical tubes, and sliders are arranged on the vertical tubes; each side frame comprises one or more X-shaped connecting tubes which are hinged together, an upper end of either side of the side frame is riveted to the fixing seats, and lower ends of said side of the side frame is riveted to the sliders; and the chassis comprises two bottom frames, inner sides of the bottom frames are riveted together, and outer sides of the bottom frames are riveted to the lower horizontal tubes.

Furthermore, a handlebar capable of rotating forward and backward is arranged on the front frame.

Furthermore, a detachable storage bag is arranged in the cart frame.

Furthermore, the cart frame further comprises a U-shaped bottom tube, a horizontal tube of the U-shaped bottom tube is located below the chassis, and two vertical tubes of the U-shaped bottom tube are riveted to the two side frames.

By adopting the technical solution of the invention, the invention has the following beneficial effects: users can synchronously brake the two rear casters by stepping on the brake pedal with one foot, such that the cart can be stopped more quickly in the moving process, the moving distance of the cart after braking is reduced, and the braking efficiency of the cart is improved; the handle tube can drive the left shells to rotate with respect to the right shells, the limit pillars and wedge blocks in the left shells are in clearance fit with the grooves and wedge grooves of the locking pieces respectively, and the left shells can clamp or release the gears to realize locking or unlocking; the two side frames are connected by means of a U-shaped bottom tube, thus improving the stability of the cart frame; the canopy is arranged to cover and protect articles in the cart frame when the cart is used in rainy or other bad weathers; the side frames and the chassis are designed to be foldable, such that the cart can be horizontally folded when not used, thus reducing the storage space of the cart; and the handlebar is arranged on the front frame and the handle tube is arranged on the rear frame, such that users can pull the cart in front of the cart or push the cart behind the cart as actually needed.

### BRIEF DESCRIPTION OF THE SEVERAL VIEWS OF THE DRAWINGS

FIG. 1 is a three-dimensional view of a cart provided with a pedal capable of synchronously braking two casters according to a first structure;

FIG. 2 is an exploded view of the cart provided with a pedal capable of synchronously braking two casters;

FIG. 3 is a three-dimensional view of a cart frame;

FIG. 4 is a side view of the cart frame;

FIG. 5a is a three-dimensional view of a rear frame and rear casters;

FIG. 5b is a schematic exploded view of the rear frame and the rear casters;

FIG. 6a is a schematic exploded view of a handle tube and the rear frame from one perspective;

FIG. 6b is a schematic exploded view of the handle tube and the rear frame from another perspective;

FIG. 7a is a schematic diagram of the inner side of a left shell;

FIG. 7b is a schematic diagram of a locking piece;

FIG. 8 is a three-dimensional view of a cart provided with a pedal capable of synchronously braking two casters according to a second structure;

FIG. 9 is a three-dimensional view of a cart frame of the cart provided with a pedal capable of synchronously braking two casters according to the second structure;

FIG. 10 is a three-dimensional view of a cart provided with a pedal capable of synchronously braking two casters according to a third structure.

In the FIGS: 1, cart frame; 2, front frame; 21, vertical tube; 22, upper horizontal tube; 23, lower horizontal tube; 24, fixing seat; 25, slider; 3, rear frame; 4, side frame; 41, X-shaped connecting tube; 5, chassis; 51, bottom frame; 60, front caster; 61, rear caster; 62, hub connecting piece; 63, hub; 64, limit piece; 64a, protrusion; 64b, stop piece; 7, brake mechanism; 71, connecting tube; 72, pedal; 73, tube sleeve; 74, tube plug; 74a, limit groove; 75, positioning piece; 8, positioning and locking mechanism; 81, right shell; 82, gear; 83, left shell; 83a, hinge pin; 83b, limit pillar; 83c, wedge block; 84, locking piece; 84a, groove; 84b, wedge groove; 9, handle tube; 10, storage bag; 11, handlebar; 11a, upper rod; 11b, lower rod; 12, U-shaped bottom tube; 13, canopy; 13a, cloth cover; 13b, support rod; 13c, top rod; 13d, center seat; 13e, fixing block.

### DETAILED DESCRIPTION OF THE INVENTION

Specific embodiments of the specific solution of the invention will be further expounded below in conjunction with the accompanying drawings to gain a better understanding of the technical solution of the invention.

### Embodiment 1

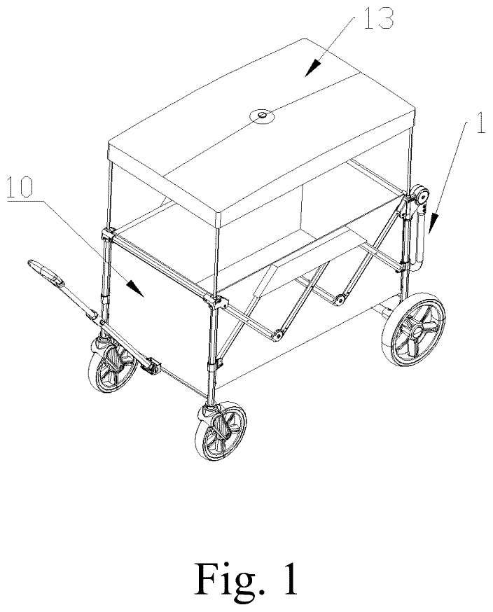

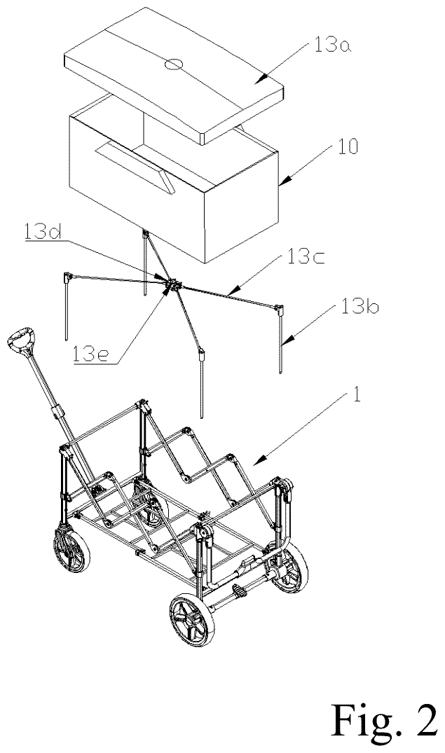

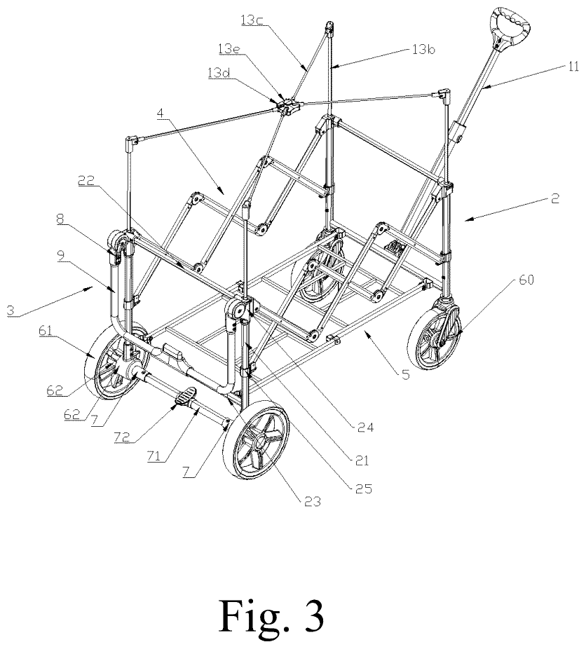

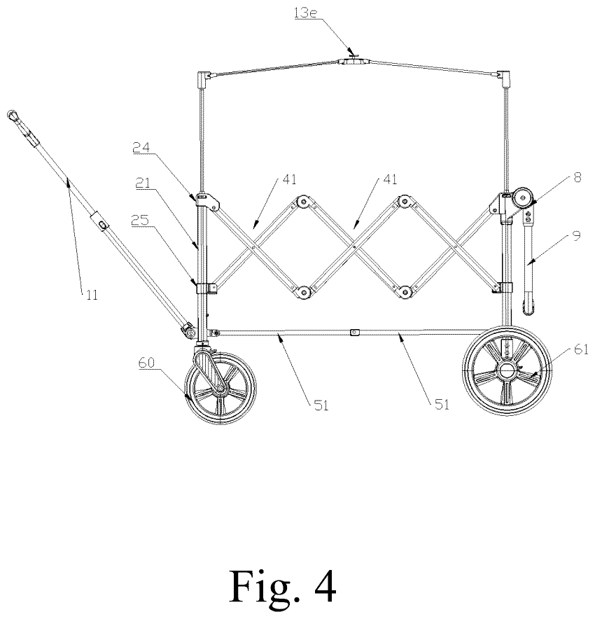

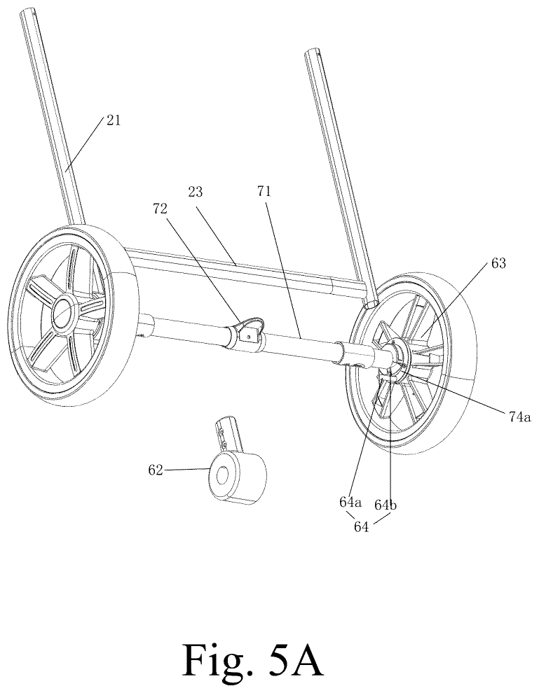

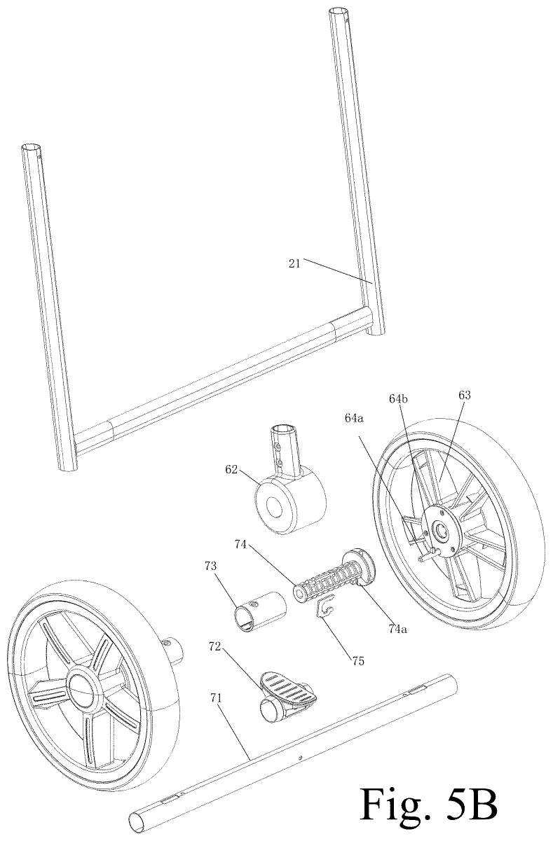

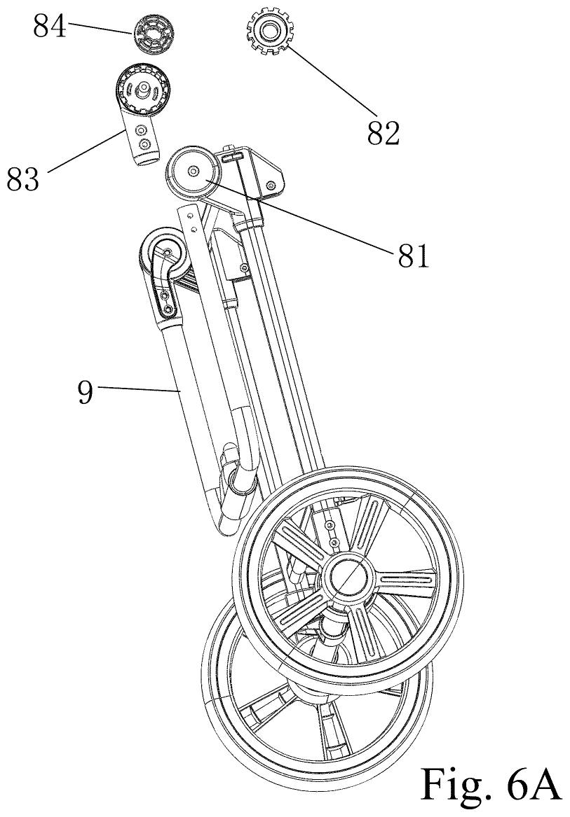

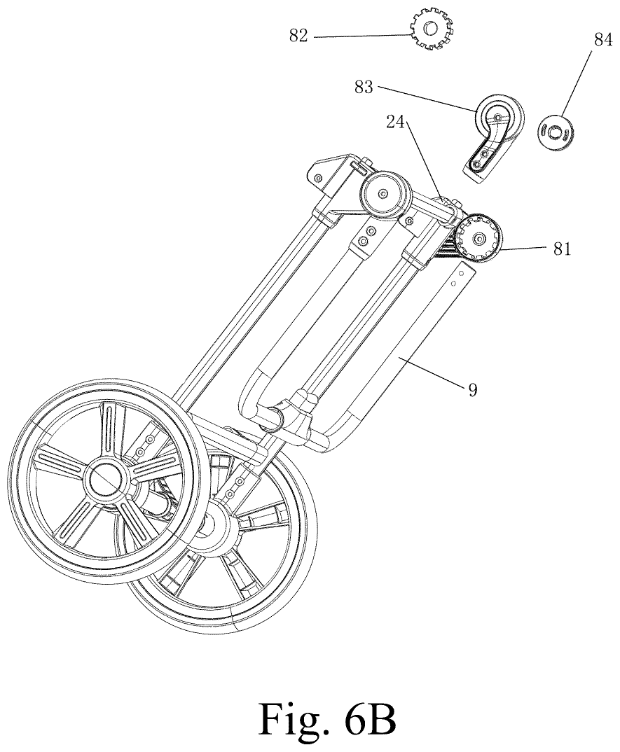

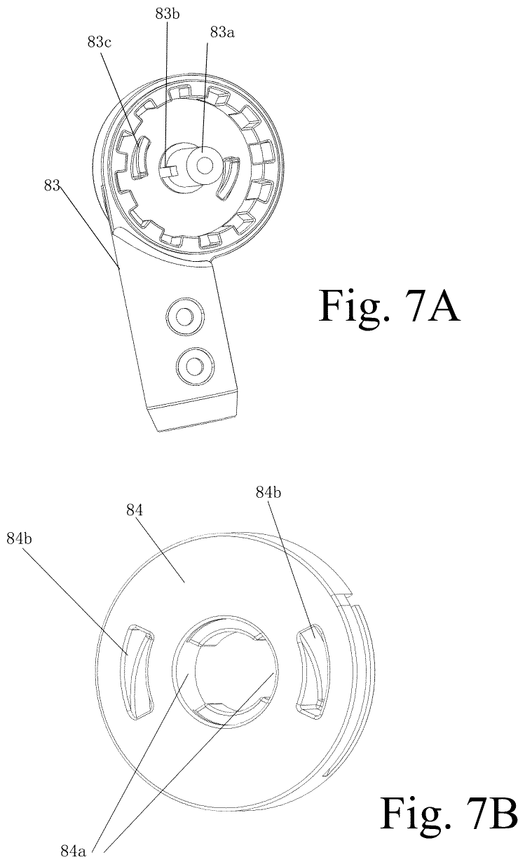

As shown in FIGS. 1-7b, a cart provided with a pedal capable of synchronously braking two casters comprises a cart frame 1, wherein two front casters 60 and two rear casters 61 are symmetrically arranged at the bottom of the cart frame 1; a brake mechanism 7 is arranged on the two rear casters 61 and comprises a connecting tube 71, a pedal 72 mounted on the connecting tube 71, and two brake assemblies mounted at ends of the connecting tube 71 respectively; and when users step on the pedal 72, the pedal 72 drives the connecting tube 71 to rotate, and limit portions of the brake assemblies abut against limit pieces 64 on the rear casters 61 to brake the rear casters.

The cart frame 1 is connected to the rear casters 61 by means of a hub connecting piece 62, each brake assembly comprises a tube sleeve 73 and a tube plug 74, the tube sleeves 73, the ends of the connecting tube 71 and the tube plugs 74 are sequentially arranged from outside to inside and fixedly connected, the limit pieces 8 of the rear casters 61 are located in limit grooves 74a in ends of the tube plugs 74, and the ends of the tube plugs 74 are rotatably connected to hubs 63 of the rear casters 61. Specifically, flanges are arranged at the ends of the tube plugs 74, and the limit grooves 74a are formed in one sides of the flanges. Each limit piece 64 comprises a protrusion 64a arranged on the hub of the corresponding rear caster and a stop piece 64b located on a side face of the protrusion 64a. After the tube plugs 74 and the hubs 63 are assembled, the stop pieces 82 are located in the limit grooves 74a. Recesses are formed in moving terminals on left and right sides of each limit groove 74a respectively. The tube plugs 74 rotate along with the connecting tube 71 to allow the stop pieces 64b to be accurately inlaid in the recesses.

When users step on the pedal 72, the pedal 72 drives the connecting tube 71 and the tube plugs 74 rotate synchronously; because the stop pieces 64b are arranged on the side faces of the protrusions 64a on inner sides of the hubs, the tube plugs 74 will stop rotating when one sides of the limit grooves 74a abut against the stop pieces 64, thus restraining rolling of the rear casters 61. In this way, users can brake the two rear casters 61 synchronously by stepping on the pedal 72 with one foot.

To further fix the tube plugs and the connecting tube, each brake assembly further comprises a positioning piece 75 mounted in the tube plug 74, and a lower end of the positioning piece 75 penetrates through a tube wall of the connecting piece 71 and the tube sleeve 73.

A handle tube 9 is arranged on a back side of the cart frame 1, two ends of the handle tube 9 are rotatably connected to two sides of the rear frame 3, and positioning and locking mechanisms 8 are arranged at the ends of the handle tube 9; each positioning and locking mechanism 8 comprises a right shell 81 mounted on the cart frame, a gear 82 fixed in the right shell 81, a left shell 83 fixed to the handle tube 9, and a locking piece 84 in clearance fit with the left shell 83. In this embodiment, the right shell 81 and a fixing seat 24 are formed integrally, slots matching the gear 82 in shape are formed in the right shell 81 and the left shell 83 respectively, and a right side of the gear is fixedly mounted in the slot in the right shell 81.

A hinge pin 83a penetrating through the locking piece 84 and the gear 82 is arranged at the center of the left shell 83, a limit pillar 83b and a wedge block 83c are arranged on portions, located on a side face of the hinge pin and outside the hinge pin, of an inner surface of the left shell 83 respectively, a groove 84a allowing the limit pillar 83b to move therein is formed in an inner wall of a center hole of the locking piece 84, and a wedge groove 84b matched with the wedge block is formed in a surface of the locking piece. The two limit pillars 83a and the two wedge blocks 83b are arranged symmetrically.

When the handle tube 9 is rotated upwards, the left shells 83 are driven to rotate, the wedge blocks 83c on the inner surfaces of the left shells 83 gradually slide into the wedge grooves 84b of the locking pieces 84, the limit pillars 83b abut one sides of the grooves 84a, and the left shells 83 move rightwards along the hinge pins 83a to clamp the left sides of the gears 82, thus locking the handle tube 9; at this moment, the handle tube 9 is locked in a horizontal state, and users can hold the handle tube 9 to push the cart. On the contrary, when the cart is not used, the handle tube 9 is rotated downwards, the left shells 83 are driven to rotate reversely, the wedge blocks 83c disengage from the wedge grooves 84b, and the left shells 83 are separated from the left sides of the gears 82, thus unlocking the handle tube 9.

A canopy 13 is mounted at the top of the cart frame 1 and comprises a cloth cover 13a and a canopy frame, wherein the canopy frame comprises four support rods 13b, four top rods 13c and a center seat 13d, the four top rods 13c are symmetrically and rotatably connected to four corners of the center seat 13b, each top rod 13c is rotatably connected to the top of one support rod 13b, and the bottom of each support rod 13b is detachably connected to the top of the cart frame. A lower end of a fixing block 13e penetrates through the cloth cover 13a to be fixed to a surface of the center seat 13b, and the periphery of the cloth cover covers the top rods 13c and tops of the support rods 13b.

The cart frame 1 comprises a front frame 2, a rear frame 3, a chassis 5 and two side frames 4, wherein the front frame 2 and the rear frame 3 are identical in structure, the front casters 60 are arranged at the bottom of the front frame 2, and the rear casters 61 are arranged at the bottom of the rear frame 3; the front frame 2 comprises a frame body formed by two vertical tubes 21, an upper horizontal tube 22 and a lower horizontal tube 23, fixing seats 24 are arranged at the tops of the vertical tubes 21, and sliders 25 are arranged on the vertical tubes 21; each side frame 4 comprises three X-shaped connecting tubes 41 which are hinged sequentially (each X-shaped connecting tube 41 is formed by cross riveting of two tubes), and an upper end of either side of the side frame 4 is riveted to the fixing seats 24, and lower end of said side of the side frame 4 is riveted to the sliders 25; and the chassis 5 comprises two bottom frames 51, inner side of the bottom frames 51 are riveted together, and outer sides of the bottom frames 51 are riveted to the lower horizontal tubes 23. The entire cart frame is foldable, thus facilitating storage and reducing the space occupied by the cart when the cart is not used.

A handlebar 11 capable of rotating forward and backward is arranged on the front frame 2.

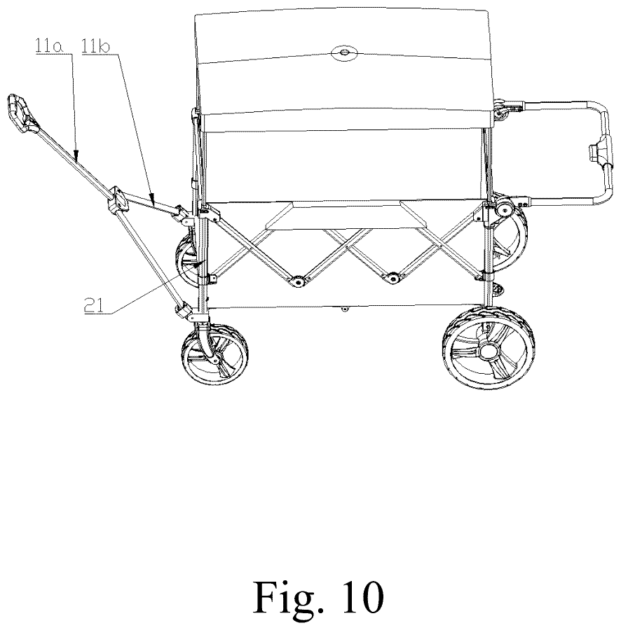

According to one structure, as shown in FIG. 1, the handlebar 11 is a telescopic tube, and the bottom of the handlebar 11 is riveted to the lower horizontal tube 23 of the front frame 2. According to another structure, as shown in FIG. 10, the handlebar 11 comprises an upper rod 11a and two symmetric lower rods 11b, the bottom of the upper rod 11a is riveted to upper ends of the two lower rods 11b, and the lower rods can rotate leftwards and rightwards with respect to the upper rod; and bottoms of the two lower rods 11b are riveted to lower ends of the two vertical tubes 21 of the front frame 2 respectively, and the lower rods 11b can rotate forwards and backwards with respect to the vertical tubes 21.

A detachable storage bag 10 is arranged in the cart frame 1. A connecting portion with a lower side being open is arranged on a side face of the storage bag 10, and the connecting portion is mounted at a hinge joint of two X-shaped connecting tubes 41.

### Embodiment 2

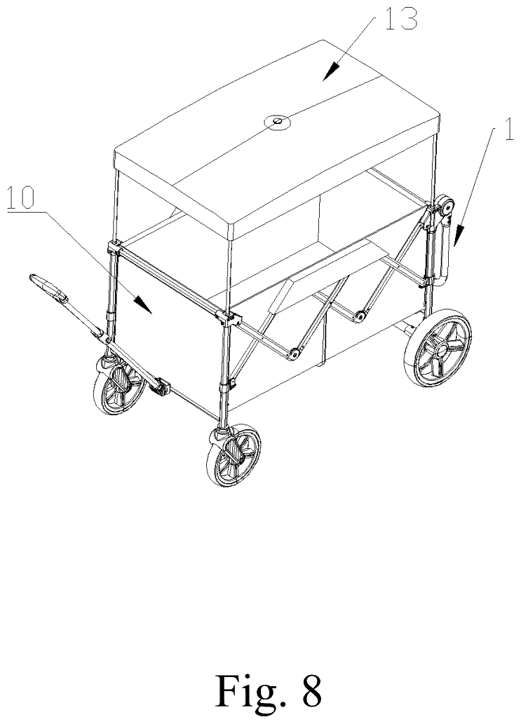

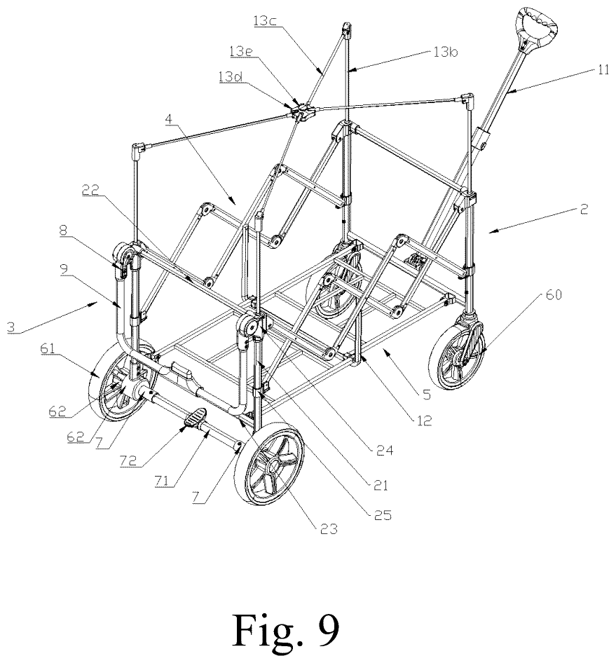

As shown in FIG. 8-FIG. 9, different from Embodiment 1, the cart provided with a pedal capable of synchronously braking two casters in this embodiment further comprises a U-shaped bottom tube 12, wherein a horizontal tube of the U-shaped bottom tube 12 is located below the chassis 5, and two vertical tubes of the U-shaped bottom tube 12 are riveted to the two side frames 4 respectively. Specifically, the two vertical tubes of the U-shaped bottom tube 12 are riveted to the X-shaped connecting tubes 41 in the middle of the side frames 4.

It should be noted that the above embodiments are merely preferred ones of the invention and are used to explain the technical principle of the invention. Those skilled in the art should understand that the invention is not limited to these specific embodiments described here, and those skilled in the art can make various obvious changes, readjustments and substitutions without departing from the protection scope of the invention. Thus, although the invention has been described in detail with reference to the above embodiments, the invention is not limited to the above embodiments, and may include more other equivalent embodiments without departing from the concept of the invention. The scope of the invention is defined by the appended claims.

What is claimed is:

1. A cart provided with a pedal capable of synchronously braking two casters, comprising:
a cart frame, wherein two front casters and two rear casters are symmetrically arranged at a bottom of the cart frame;
a brake mechanism is arranged on the two rear casters and comprises a connecting tube, a pedal mounted on the connecting tube and two brake assemblies mounted at ends of the connecting tube respectively; and
two ends of the connecting tube are connected to the two brake assemblies respectively, the pedal drives the connecting tube to rotate, and limit portions of the brake assemblies abut against limit pieces on the rear casters to bake the rear casters.

2. The cart provided with a pedal capable of synchronously braking two casters according to claim 1, wherein the cart frame is connected to the rear casters by means of a hub connecting piece, each said brake assembly comprises a tube sleeve and a tube plug, the tube sleeves, the ends of the connecting tube and the tube plugs are sequentially arranged from outside to inside and fixedly connected, the limit pieces on the rear casters are located in limit grooves in ends of the tube plugs, and the ends of the tube plugs are rotatably connected to hubs of the rear casters.

3. The cart provided with a pedal capable of synchronously braking two casters according to claim 2, wherein flanges are arranged at the ends of the tube plugs, a limit groove is formed in a side of each said flange, each said limit piece comprises a protrusion arranged on the hub of the corresponding rear caster and a stop piece located on a side face of the protrusion, and the stop pieces are located in the limit grooves.

4. The cart provided with a pedal capable of synchronously braking two casters according to claim 3, wherein each said brake assembly further comprises a positioning piece mounted in the tube plug and penetrating through the corresponding end of the connecting tube.

5. The cart provided with a pedal capable of synchronously braking two casters according to claim 1, wherein a handle tube is arranged on a back side of the cart frame, two ends of the handle tube are rotatably connected to two sides of the back side of the cart frame, and positioning and locking mechanisms are arranged at the ends of the handle tube; and each said positioning and locking mechanism comprises a right shell mounted on the cart frame, a gear fixed in the right shell, a left shell fixed to the handle tube and a locking piece in clearance fit with the left shell.

6. The cart provided with a pedal capable of synchronously braking two casters according to claim 5, wherein the left shell is provided with a hinge pin penetrating through the locking piece and the gear, a limit pillar and a wedge block are arranged on portions, located on a side face of the hinge pin and outside the hinge pin, of an inner surface of the left shell respectively, a groove allowing the limit pillar to move therein is formed in an inner wall of a center hole of the locking piece, and a wedge groove matched with the wedge block is formed in a surface of the locking piece.

7. The cart provided with a pedal capable of synchronously braking two casters according to claim 1, wherein a canopy is mounted at a top of the cart frame and comprises a cloth cover and a canopy frame, the canopy frame comprises four support rods, four top rods and a center seat, the four top rods are symmetrically and rotatably connected to four corners of the center seat, each said top rod is rotatably connected to a top of one said support rod, and a bottom of each said support frame is detachably connected to the top of the cart frame.

8. The cart provided with a pedal capable of synchronously braking two casters according to claim 1, wherein the cart frame comprises a front frame, a rear frame, a chassis and two side frames, the front frame and the rear frame are identical in structure, the front casters are arranged at a bottom of the front frame, and the rear casters are arranged at a bottom of the rear frame; the front frame comprises a frame body formed by two vertical tubes, an upper horizontal tube and a lower horizontal tube, fixing seats are arranged at tops of the vertical tubes, and sliders are arranged on the vertical tubes; each said side frame comprises one or more X-shaped connecting tubes which are hinged together, an upper end of either side of the side frame is riveted to the fixing seats, and lower ends of said side of the side frame is riveted to the sliders; and the chassis comprises two bottom frames, inner sides of the bottom frames are riveted together, and outer sides of the bottom frames are riveted to the lower horizontal tubes.

9. The cart provided with a pedal capable of synchronously braking two casters according to claim 8, wherein a handlebar capable of rotating forward and backward is arranged on the front frame; or, a detachable storage bag is arranged in the cart frame.

10. The cart provided with a pedal capable of synchronously braking two casters according to claim 8, wherein the cart frame further comprises a U-shaped bottom tube, a horizontal tube of the U-shaped bottom tube is located below the chassis, and two vertical tubes of the U-shaped bottom tube are riveted to the two side frames.

11. The cart provided with a pedal capable of synchronously braking two casters according to claim 9, wherein the cart frame further comprises a U-shaped bottom tube, a horizontal tube of the U-shaped bottom tube is located below the chassis, and two vertical tubes of the U-shaped bottom tube are riveted to the two side frames.
